(19) United States
(12) Patent Application Publication
(10) Pub. No.: US 2007/0001137 A1
(43) Pub. Date: Jan. 4, 2007

(54) Precision metering valve

(75) Inventors: Kenji A. Kingsford, DeVore, CA (US); Allen Rodemeyer, Corona, CA (US); David R. Martinez, Corona, CA (US)

Correspondence Address: Mike W. Crosby;Saint-Gobain Corporation, 1 New Bond Street, Box 15138, Worcester, MA, 01615-0138, US

(73) Assignee: Saint-Gobain Perfomance Plastics Corporation, Wayne, NJ (US)

(21) Appl. No.: 11/109,473

(22) Filed: Apr. 18, 2005

(51) Int. Cl. F16K 47/00

(52) U.S. Cl. 251/122; 137/625.3

(57) ABSTRACT

Precision metering valves include a body having a fluid inlet port, a fluid outlet port, a fluid chamber interposed therebetween, and an orifice disposed within the fluid chamber. The orifice has an opening that extends a length along the fluid chamber. A movable element is disposed within the fluid chamber, and includes a stem that is at least partially disposed within the orifice to control the flow of fluid through the valve. The stem and/or the orifice includes an outside surface feature configured to adjust the flow rate of fluid through the valve as a function of stem insertion depth within the orifice. A thin-walled section extends from the stem and extends axially therefrom. The thin-walled section has a sufficient length to facilitate axial stem movement of the stem by rolling transfer. A flange projects from the thin-walled section and extends circumferentially therearound.

### FIELD OF THE INVENTION

The present invention relates generally to valves used to provide an accurate flow rate delivery of fluid and, more particularly, to a valve that is specially designed to provide a low flow delivery of fluid in a manner that is stable and repeatable at extremely low flow settings.

### BACKGROUND OF THE INVENTION

Valves that are used in, for example, the semiconductor manufacturing industry for the purpose of dispensing a metered or measured volume of high-purity process fluid such as corrosive and/or caustic process fluids for semiconductor processing are known in the art. In such an application, it is important that the metered volume of the process fluid being delivered by the valve be accurate, and that the accurate delivery of such fluid be consistent. It is also important that the process fluid being delivered by such valve be done in a manner that maintains the fluid's high level of purity. Accordingly, it is important that metering valves placed into such service not introduce contaminant matter that can be transferred downstream, which could eventually damage or contaminate the high-purity finished product, e.g., semiconductors and the like.

These high purity process fluids are oftentimes heated to temperatures near their boiling point to increase their efficiency in performing the particular semiconductor manufacturing process. Accordingly, it is important that metering valves placed into service with such process fluids be capable of delivering such corrosive and/or caustic process fluids under high-temperature conditions without adversely impacting the accuracy of fluid delivery or otherwise failing.

Conventional valves used for delivering process fluids in such application are needle valves that generally comprise a valve body including a fluid inlet, a fluid outlet, and a fluid chamber interposed between the fluid inlet and outlet. The fluid chamber includes a circumferential orifice or seat that is generally positioned downstream from the fluid inlet and upstream from the fluid outlet. A movable element is disposed axially within the fluid chamber and includes a pointed end that is tapered and sized to fit within the orifice or seat. Such valve is referred to as a “needle” valve because of the slender and pointed nature of the movable element. Such needle valve includes an actuating means, mechanical, pneumatic, hydraulic or manual, that permits the position of the movable element to be changed relative to the orifice. This displacement of the movable element relative to the orifice provides a variable orifice restriction by changing annular open surface area between the two, which thereby changes the flow rate of fluid therebetween and through the valve.

However, a problem known to exist with such needle valves is that they have difficulty in providing a stable and repeatable delivery of fluid at extremely low flow settings. This is due to the configuration and interaction of the movable element within the orifice. To achieve low flow rate conditions through the needle valve, the movable element must be positioned within the fluid chamber with the pointed or tapered end disposed within the orifice such that the annular space existing therebetween is relatively small. However, the configuration of the movable element tapered outside surface within and adjacent to the circumferential orifice produces a fluid delivery flow rate that is curved and not linear as a function of the movable element placement within the valve.

Thus, a characteristic feature of such needle valves is that very small movements of the movable element relative to the orifice will produce relatively large changes in the annular space that is formed therebetween and the related fluid flow rate, which is especially pronounced at low flow conditions. This characteristic feature makes it very difficult to deliver in a stable and repeatable fashion fluids at low flow conditions using such needle valves.

Further, such needle valves are known to use a conventional annular stem seal that is disposed around the movable element and that is used to provide a seal between the moveable element and the valve body. The stem seal is a wetted part within the valve that inherently has a percentage of fluid leakage thereby that typically increases with time. When such a valve is used in a semiconductor processing application where highly corrosive chemical fluids, the existence of any such leak path and fluid leakage is not desired for the purpose of reducing or eliminating any potential health, safety or environmental risk that could be associated therewith.

It is, therefore, desired that a valve be constructed that is capable of delivering in a repeatable and stable manner an accurate volume of fluid, such as that used in the semiconductor manufacturing industry, and low flow conditions. It is further desired that such valves be constructed in a manner that facilitates the desired delivery of fluids in a manner that minimizes or eliminates the possibility of leakage issues that could adversely impact accurate fluid dispensement and/or present a health, safety or environmental issue.

### SUMMARY OF THE INVENTION

Precision metering valves of this invention include a body that has a fluid inlet port, a fluid outlet port, and a fluid chamber interposed therebetween. An orifice is disposed within the fluid chamber, includes an opening, and has a length that extends along the fluid chamber. The orifice has a substantially constant diameter along the length. In an example embodiment, the orifice is integral with the valve body.

The valve includes a movable element that is disposed within the valve body fluid chamber. The movable element includes a stem that is at least partially disposed within the orifice to control the flow of fluid through the valve. At least one of the stem or the orifice includes an outside surface feature that is configured to adjust the flow rate of fluid through the valve as a function of stem insertion depth within the orifice.

The movable element includes a thin-walled section that is integral with the stem and that extends axially therefrom. The thin-walled section has a substantially cylindrical shape and is sized having a sufficient length to facilitate axial movement of the stem by rolling transfer of the thin-walled section from one supporting surface to an adjacent and oppositely oriented supporting surface of the valve. A flange is integral with the thin-walled section and extends circumferentially therearound to define a peripheral edge of the moveable element. In an example embodiment, the stem, thin-walled section and flange are all integral with the moveable member, and the movable member is of a one-piece construction.

The valve includes an actuator connected to the movable element to cause axial movement of the movable element within the valve body. The actuator is disposed within an actuator housing that is attached to the valve body.

Precision metering valves of this invention provide a desired stable and repeatable delivery of fluid via use of the specially configured stem and/or orifice outside surface features that are sized and shaped to produce, in example invention embodiments, a fluid flow rate for the valve that changes in a linear manner with respect to stem displacement within the orifice. This operates to provide an enhanced degree of stability and repeatability with respect to fluid delivery at low flow conditions when compared to conventional needle valves. Further, precision metering valves of this invention avoid the use of dynamic seals, and have wetted components that are formed entirely from chemically inert non-metallic materials, thereby operating to eliminate the possibility of process fluid contamination that may occur from deteriorating or corroding materials.

### DESCRIPTION OF THE DRAWINGS

These and other features and advantages of the present invention will become appreciated as the same becomes better understood with reference to the specification, claims and drawings wherein:

FIG. 1A is a cross-sectional side view of a first embodiment metering valve constructed according to principles of this invention;

FIG. 1B is an enlarged cross-sectional side view of a section of the metering valve of FIG. 1A;

FIG. 2 is a perspective side view of a valve element of the first embodiment metering valve of FIG. 1A;

FIG. 3 is a cross-sectional side view of a second embodiment metering valve of this invention;

FIG. 4 is an perspective side view of the second embodiment metering valve of FIG. 3 illustrating the valve elements in an unassembled state;

FIG. 5 is a cross-sectional side view of a third embodiment metering valve of this invention;

FIG. 6 is a cross-sectional side view of a fourth embodiment metering valve of this invention; and

FIGS. 7A and 7B are a cross-sectional side view and a side view, respectively, of a valve element of the fourth embodiment metering valve of FIG. 6.

### DETAILED DESCRIPTION OF THE INVENTION

This invention relates to valves useful for delivering accurate volumetric flow rates of fluids, and more specifically, to valves useful for the stable and repeatable delivery of high-purity process fluids such as those used in the semiconductor manufacturing industry at low volumetric flow rates. Valves of this invention make use of a rolling diaphragm cylindrical valve element that is movably disposed within a fluid chamber and that is configured to provide high degree of stability, reliability and control of fluid delivery, e.g., providing a substantially linear fluid flow curve as a function of volumetric flow rate and valve element movement.

The valve includes internal wetted elements, including the valve movable element, that are made from chemically inert materials resistant to corrosive, abrasive, and caustic process fluids, are not formed from metal, and are constructed without the use of dynamic seals. Valves of this invention can be adjusted or actuated by conventional means, such as by electric motor like a stepper motor, pneumatically, hydraulically, mechanically, manually or the like.

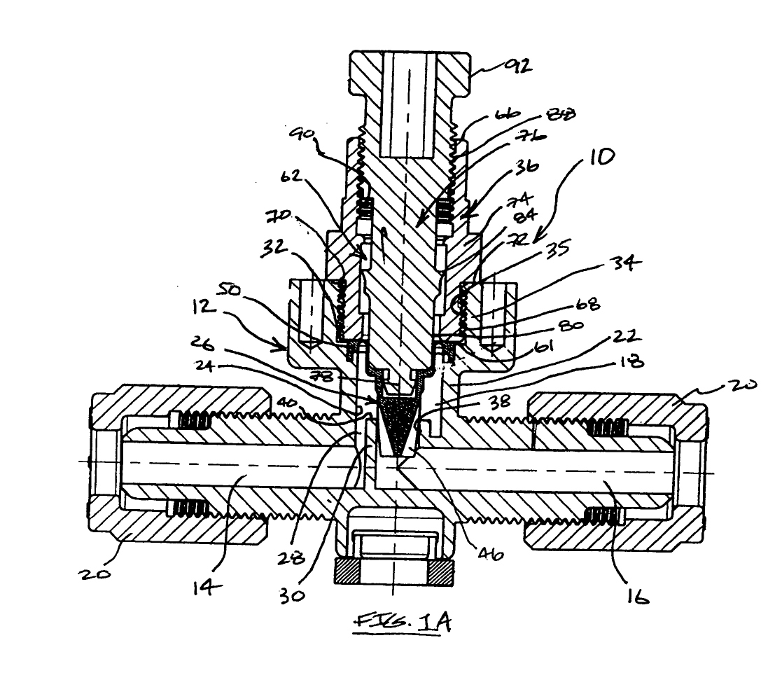

FIG. 1A illustrates a first embodiment metering valve 10 of this invention comprising a valve body 12 that includes a fluid inlet port 14, a fluid outlet port 16, and an internal fluid chamber 18 that is interposed therebetween. In an example embodiment, the valve body is of a one-piece construction such that the above-noted elements are integral components of, and formed from the same materials as, the valve body. The fluid inlet and outlet ports 14 and 16 have outside surfaces that are configured to permit attachment using conventional coupling members 20 with conventional fluid transport conduits such as piping, tubing and the like, e.g., by threaded or interference connection.

In an example embodiment, the fluid inlet projects outwardly away from the valve body in a direction opposite from the fluid outlet. Alternatively, the fluid inlet and/or outlet ports can be configured to be connected to fluid conduits in a fluid handling system by welding, e.g., ultrasonic welding. It is, however, to be understood that the exact placement and orientation of the fluid inlet and fluid outlet in the valve body can and will vary depending on the particular metering valve application.

Materials used to construct the valve body of this invention can vary depending on intended use application. For non-critical applications, e.g., whether the fluid being transported is not an aggressive chemical and/or is not high purity, the valve body an all wetted parts can be formed from conventional structural materials known for making conventional valves, e.g., polymeric materials and/or metallic materials. However, for use in the application of making semiconductors, where aggressive chemicals and/or high-purity chemicals are used, it is desired that the valve body and wetted members within the valve body be formed from a non-metallic chemically resistant material, such as a fluoropolymeric material.

Suitable fluoropolymeric materials include those selected from the group including of polytetrafluoroethylene (PTFE), fluorinated ethylene-propylene (FEP), perfluoroalkoxy fluorocarbon resin (PFA), polychlorotrifluoroethylene (PCTFE), ethylenechlorotrifluoroethylene copolymer (ECTFE), ethylene-tetrafluoroethylene copolymer (ETFE), polyvinylidene fluoride (PVDF), polyvinyl fluoride (PVF) and the like. A particularly preferred material useful for forming the body 12 is PFA. Alternatively, in non-semiconductor applications, other types of structurally rigid material that may include metallic materials can be used. The body can be formed by molding or machining process. In an example, the body is formed by molding.

The fluid chamber 18 is located within the valve body downstream from the fluid inlet port 14 and is located within a neck 22 of the valve body that extends outwardly and upwardly away from the fluid inlet and outlet ports, and is defined by a surrounding inside wall surface 24 of the neck 22. The fluid chamber 18 is sized having a diameter that both accommodates placement of a valve movable element 26 therein and permits a desired flow of fluid therethrough. In an example embodiment, the fluid inlet port 14 communicates with the fluid chamber 18 via an internal passage 28 that is separated from the fluid outlet by an internal wall 30 that is configured to isolate the fluid outlet port from the fluid inlet port within the valve body.

The fluid chamber includes an open end 32 that is positioned adjacent an upper portion of the valve body, and that is sized and configured to receive and accommodates placement of the valve movable element 26 therein. The end of the valve body opposite the open end 32 is closed such that the only remaining openings in the valve body include the fluid inlet and outlet ports. If desired, the bottom portion of the valve body can be configured having a surface feature adapted to permit fixing or mounting the valve body to an adjacent surface.

Moving upwardly from the fluid chamber open end 32, the valve body includes an enlarged diameter section 34 that extends axially upwardly a distance away from the fluid chamber open end 32 and that includes an inner wall surface 35 of the valve body. The enlarged diameter section is sized and shaped to accommodate placement of an actuator housing 36 therein. In an example embodiment, the enlarged diameter section inner wall surface 35 is threaded to facilitate threaded coupling of the actuator housing 36 therewith.

The valve body 12 includes a valve orifice 38 that is positioned within the fluid chamber 18 and that is generally cylindrical in shape and that extends a distance axially within the fluid chamber from a top surface 40 of the orifice. In an example embodiment, the orifice is defined at least partially by the internal wall 30. Further, the orifice 38 has a constant diameter throughout its axial length and is sized, in diameter and length, to accommodate placement of a cooperating section of the valve movable element 26 therein with a desired degree of tolerance, e.g., a degree of tolerance that both permits axial movement of the cooperating section of the valve movable element therein while also minimizing or preventing fluid leakage therebetween. In an example embodiment, the orifice 38 is positioned upstream of and in fluid communication with the fluid outlet port 16, and in a preferred embodiment, is formed as a portion of the fluid outlet port itself.

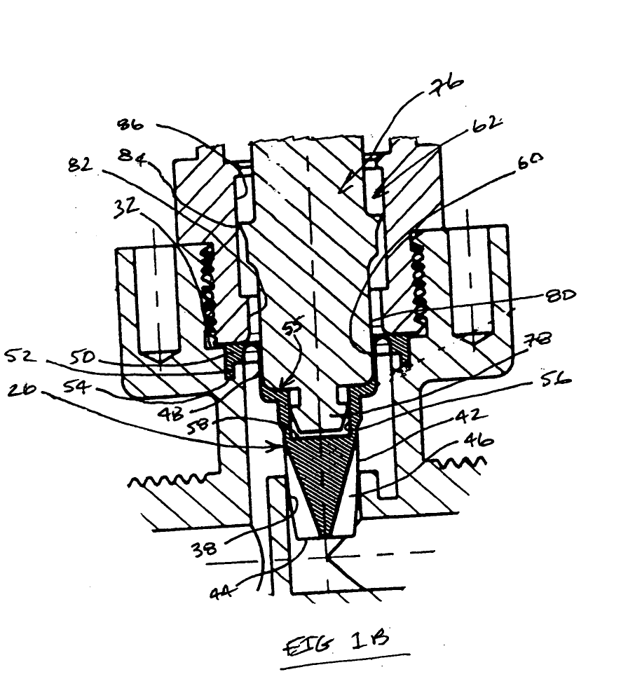

Referring to FIGS. 1A, 1B, and 2, the valve movable element 26 is a one-piece construction that includes a stem 42 that projects axially a length to a tip 44. The stem is sized having a diameter and length to fit within the valve orifice 38. A feature of the metering valve of this invention is the manner in which the stem and orifice cooperate with one another to provide a desired delivery of fluid at low flow conditions that operates to provide improved stability and repeatability when compared to conventional needle valves. Metering valves of this invention are constructed having a specially engineered stem 42 and orifice 38 to provide a substantially linear flow curve for the valve (volumetric flow rate as a function of stem position) that operates to achieve this improved degree of stability and repeatability.

In this first embodiment metering valve 10, the stem 42 is configured having a generally cylindrical shape that is sized having a diameter that provides an interference fit with the orifice when placed therein. As noted above, the tolerance between the stem and orifice is that which will permit axial stem movement therein while also minimizing or preventing fluid leakage or bypass therebetween. The stem is configured having one or more recessed sections 46 that are specially configured to provide a controlled desired degree of fluid passage between the stem and the orifice for fluid delivery by the valve.

As best shown in FIG. 2, in this example embodiment, the stem recessed section 46 is provided in the form of a V-shaped recess or groove that begins a distance axially away from the tip and that increases in depth moving towards the tip. Configured in this manner, the recess operates to provide a substantially linear change in fluid flow rate with change of stem position within the orifice that operates to provide improved operational stability and repeatability, especially at low flow conditions. The exact shape and number of the recessed section 46 of the stem can and will vary depending on the particular fluid flow application. For example, the metering valve of this invention can include a stem 42 that has more than one recessed section 46 and/or recessed sections that are differently shaped and/or sized to achieve desired valve fluid flow delivery characteristics. In an example embodiment, the stem is a solid construction and is imperforate, i.e., does not include any openings that extend through it to an inner or backside portion of the valve movable element.

The first embodiment metering valve 10, illustrated in FIGS. 1A and 1B, is shown having at least two recessed sections 46 that are diametrically opposed from one another. This embodiment could further include a stem 42 having two other diametrically opposed recessed sections that are not shown, for a total of four recessed sections positioned at 45 degree intervals around the stem surface. Again, it is to be understood that the exact shape and number of stem recessed sections can and will vary depending on the particular fluid delivery characteristics desired to meet the demands of a particular valve application.

With metering valves configured in this manner, fluid flow through the valve decreases with increasing depth of placement of the stem within the orifice. For example, when the stem is placed into an initial position about half way into the orifice a relatively high rate of fluid flow through the valve will be achieved by the relatively increased open or exposed surface area existing between the orifice 38 and the recessed section 46. As the stem is moved to a deeper position within the orifice, the open or exposed surface area existing between the orifice and the recessed section 46 is decreased, resulting in a corresponding reduction in fluid passage therebetween and fluid flow delivery from the valve.

Referring back to FIG. 1B, moving upwardly away from the stem 42, the valve movable element 26 includes a thin-walled section 48 that extends axially away from the stem a distance that is calculated to provide a desired degree of movable element axial displacement within the valve. Specifically, the thin-walled section 48 is specially constructed to enable axial movement of the movable element 26 within the valve by rolling transfer of opposite surfaces of the thin-walled section between adjacent surfaces of the valve, which will be further described below. Thus, it is desired that the thin-walled section have a thickness that will both facilitate such rolling transfer without compromising strength and service life.

Moving radially away from the thin-walled section 48, the movable element 26 includes a flange 50 that defines a peripheral circumferential edge of the movable element. The flange includes an axial surface configured to provide a leak-tight interference fit with an adjacent surface of the valve body. In an example embodiment, the flange axial surface and valve body surface adjacent the open end 32 are configured having complementary surface features that provide a tongue-in-groove attachment mechanism therebetween. In a preferred embodiment, the flange axial surface includes a tongue 52 that is sized having a width that is slightly larger than the width of a groove 54 disposed within the facing surface of the valve body opening to provide a leak-tight interference fit therebetween.

The movable element 26 includes an inner surface 55 that includes a first open section 56 that extends axially a distance from a backside 58 of the stem 42, and second open section 60 that extends axially a distance from the first open section and that is defined by an inside wall surface of the thin-walled section 48. In this example embodiment, the diameter of the first open section 56 is less than that of the second open section 60. As better described below, the first and second open sections of the movable element inner surface 55 are sized and configured to accommodate placement therein of different portions of an actuator.

As noted above, the valve movable element 26 is a one-piece construction such that all of the above-described components of the movable element 26 are formed from the same material and are integral with one another. Since the valve movable element 26 is one that is wetted with the fluid delivered by the valve, it can be formed from the same types of materials noted above for forming the valve body. In an example embodiment, where the valve body is being used to deliver high-purity and/or corrosive process chemicals for use in semiconductor manufacturing, the valve movable element is preferably formed by machine or molding process from a fluoropolymeric material.

Referring to FIG. 1A, the valve movable element 26 is held in place within the valve body 12 by the attachment of the actuator housing 36 therewith. In an example embodiment, the actuator housing 36 is threadably coupled with the enlarged diameter section 34 of the valve body and includes an axial end surface 61 that contacts and urges the movable element flange 50 against the opposed axial surface of valve body open end 32 to provide the above-described leak-tight seal therebetween.

The actuator housing 36 is a generally cylindrical member having an hollow inside chamber 62 that extends axially therethrough from a first housing end 61 to an opposed second housing end 66. Moving away from the first housing end 61, that is positioned against the valve movable element flange 50, the actuator housing 36 has an outside surface including a threaded section 68 that is designed to threadably engage and couple with the inside surface 35 of the valve body enlarged diameter section 34, and a shoulder 70 that is configured to abut against an open end 72 of the valve body enlarged diameter section 34. The actuator housing includes a further section 74 that extends axially away from the shoulder 72 to the second end 66.

The actuator housing is a non-wetted component of the valve and, thus can be formed from any suitable structurally rigid material, including metallic materials and polymeric materials such as polypropylene or the like. In an example embodiment, the actuator housing is made from polypropylene. Whether the actuator housing is formed by machining or molding process will depend on the specific types of material chosen, the particular manufacturing capabilities, and the project budget.

Referring to FIGS. 1A and 1B, an actuator 76 is disposed axially within the actuator housing chamber 62 and is provided in the form of a solid generally cylindrical member that has a head 78 at one of its ends that is positioned within the valve movable element first open section 56. In an example embodiment, the head 78 is configured to provide an interlocking engagement with the movable element to ensure that the movable element moves axially with the actuator in both axial directions. In an example embodiment, the head is formed having a flared outside surface feature that is captured by an opposed surface feature of the valve movable element.

Moving axially away from the head 78, the actuator 76 includes a first diameter section 80 that is positioned adjacent to an inside surface of the movable element thin-walled section 48. The first diameter section 80 has a diameter that is slightly less than that of the inside surface of the thin-wall section and is configured to providing a supporting structure for the thin-wall section. The actuator first diameter section 80 extends partially into the valve body and partially into the actuator housing chamber 62.

The actuator first diameter section 80 extends partially into the housing chamber 62 and through a housing first diameter section 82. The actuator housing first diameter section 82 is sized having a diameter that corresponds closely to the inside surface of the valve movable element thin-walled section when it is transferred from the actuator to provide a supporting backing thereto. In an example embodiment, the difference in size between the actuator first diameter section 80 and the housing first diameter section 82 is that which is necessary to provide a sufficient roll diameter in the movable element thin-walled section to produce a smooth rolling mechanism of thin-walled section transfer between the adjacent first diameter surfaces.

The actuator includes, moving axially away from the first diameter section 80, an enlarged diameter section or feature 84 that is sized to fit within a corresponding second diameter section 86 of the actuator housing. In an example embodiment, the actuator enlarged diameter section 84 is sized slightly smaller than that of the housing second diameter section and the cooperation between the two adjacent surfaces operates to provide a guiding feature to the actuator, thereby preventing unwanted lateral movement of the actuator within the actuator housing and valve body.

Moving axially away from the enlarged diameter section 84, the actuator includes a threaded section 88 that is configured to threadably engage a corresponding threaded section 90 of the housing chamber 62. The threaded cooperation between the actuator and housing operates to translate rotational movement of the actuator relative to the housing to axial movement of the actuator, which operates to provide axial displacement of the valve movable element within the orifice to obtain the desired fluid flow rate through and fluid delivery from the valve.

Moving axially away from the threaded section 88, the actuator 76 finally includes an outwardly projection section 92 that is positioned adjacent an end of the actuator opposite from the head 78, that projects outwardly away from the housing chamber 62, and that is configured to facilitate rotatable movement of the actuator by hand, machine or other means. In an example embodiment, the outwardly projecting section 92 is configured having a slightly enlarged diameter relative to the threaded section and comprises surface features that facilitate grasping the actuator by hand for rotating it relative to the valve body.

The actuator is a non-wetted component of the valve, and thus can be formed from the same types of materials described above for forming the actuator housing.

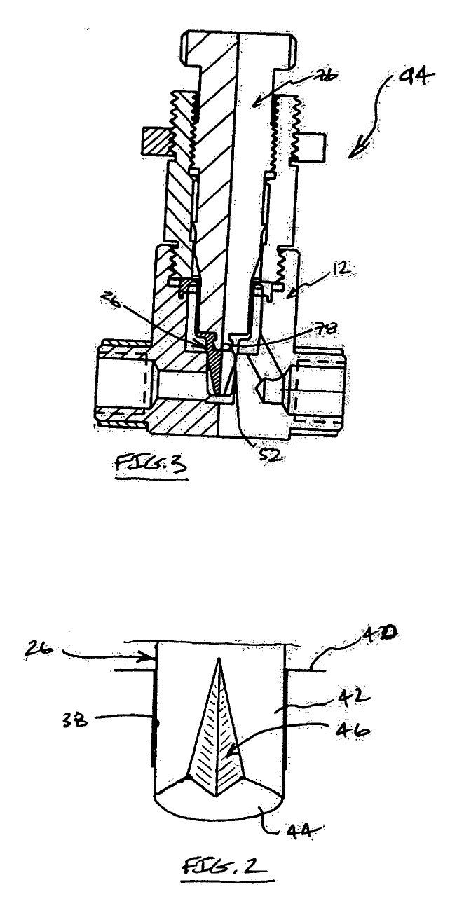

FIG. 3 illustrates a second embodiment metering valve 94 of this invention comprising many of the same general elements and features described above for the first embodiment metering valve. This embodiment more clearly shows the engagement of the actuator head 78 with the first open section 52 of the valve movable element 26 to provided an interlocking attachment therewith. This interlocking attachment is one that both facilitates assembly of the valve and one that ensures that the movable element travels with the actuator 76 when the actuator is moved in an axial direction being withdrawn from the valve body 12.

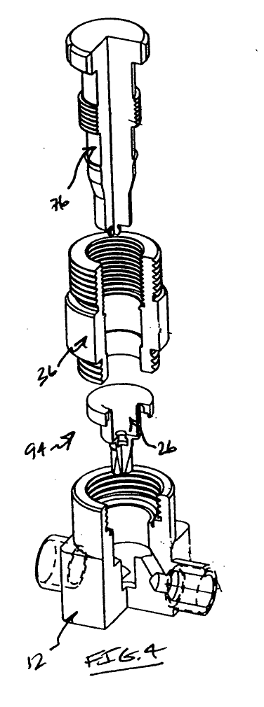

FIG. 4 illustrates the second embodiment metering valve 94 showing the main elements; namely, the valve body 12, valve movable element 26, actuator housing 36 and actuator 76, in an unassembled state for the purpose of further understanding the relationship of each element to one another and the particular features of each individual element.

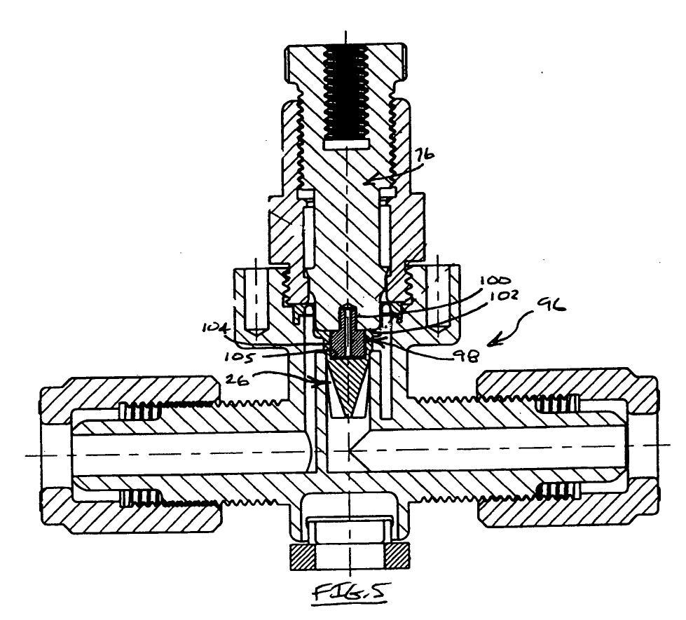

FIG. 5 illustrates a third embodiment metering valve 96 of this invention comprising the same general elements and features described above for the first embodiment metering valve. Unlike the first embodiment, this third metering valve embodiment includes the use of an intermediate connecting element 98 that is interposed between the actuator 76 and the valve movable element 26 to provide a desired attachment therebetween. In this particular embodiment, the intermediate connecting element 98 is provided in the form of an elongate member having a first end 100 with surface features designed to engage cooperative surface features of an end 102 of the actuator 76, and a second end 104 with surface features designed to engage cooperative surface features of the movable element backside 105 or inner surface.

In a preferred embodiment, the connecting element first end 100 is in the form of an outwardly projecting member having a barbed outside wall surface configured to fixedly engage a wall surface of a cavity disposed within end 102 of the actuator 76, and the connecting element second end 104 is an outwardly projecting member also having a barbed outside wall surface configured to fixedly engage a wall surface of the first open section of the movable element to provide the desired interlocking connection therebetween.

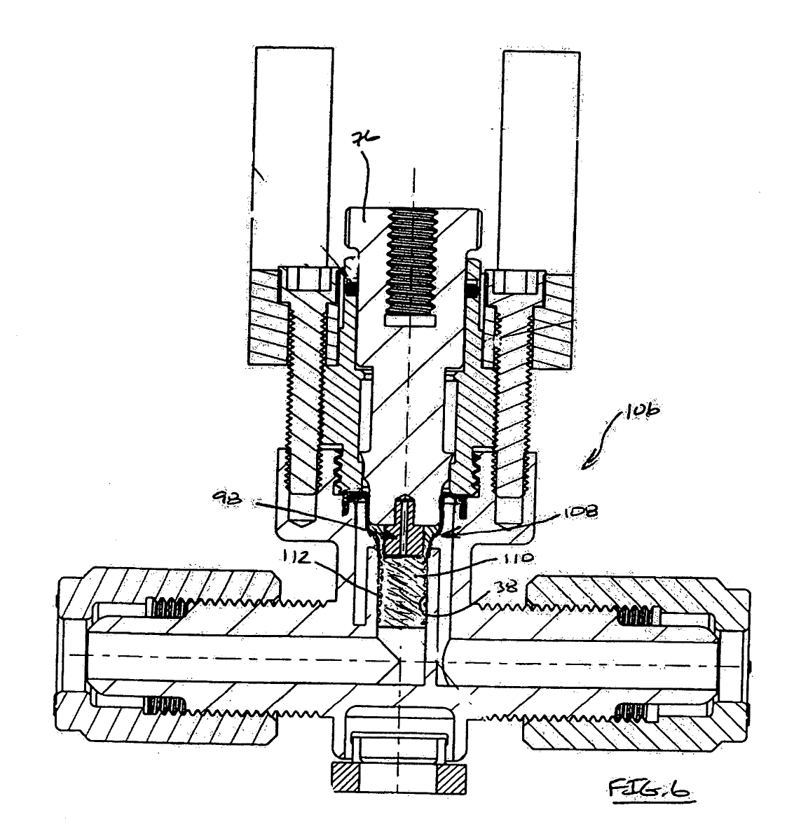

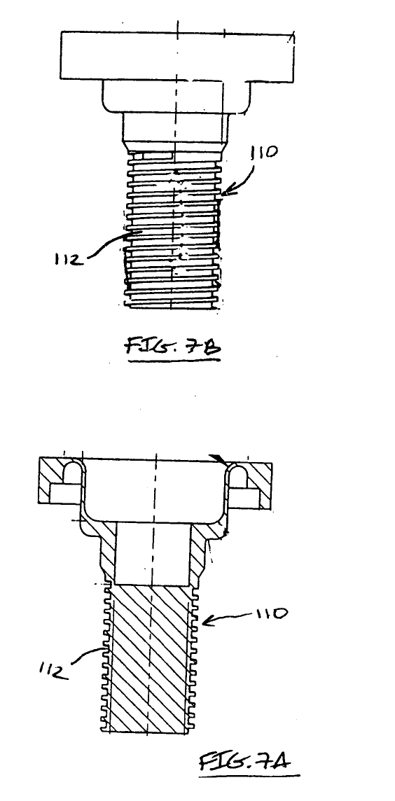

FIG. 6 illustrates a fourth embodiment metering valve 106 of this invention comprising the same general elements and features described above for the first embodiment metering valve. Unlike the first embodiment metering valve, however, the fourth embodiment metering valve includes a differently configured valve movable element 108. Specifically, the valve movable element 108 in this particular comprises a stem 110 having a helical or spiral groove 112 that is recessed within the stem outside surface. As best illustrated in FIGS. 7A and 7B, the moveable element stem 110 outside surface appears to be threaded, comprising a continuous groove 112 that runs helically therearound. Configured in this manner, when the stem 110 is displaced within the valve orifice 38, the helical groove or recess 112 operates to provide a fluid flow path therebetween that governs the flow rate of fluid delivery through the valve.

This particular embodiment is especially well suited for providing high levels of stability and repeatability for extremely low fluid flow rate settings. Deeper insertion of the stem within the orifice operates to increase the fluid flow path within the valve, thereby operating to reduce the flow rate of fluid delivered by the valve. Control over the flow rate can be custom tailored using such a surface-modified stem by changing such surface features as the width of the groove, the depth of the groove, and the pitch of the groove.

The valve movable element 108 of this fourth embodiment metering valve 106 can be attached to the actuator 76 in the same manner as the invention embodiments described above. In this particular embodiment, the valve movable element is connected to the actuator by use of an intermediate connecting element 98 as described above and illustrated in FIG. 5.

Metering valves of this invention are constructed to provide a desired stable and repeatable delivery of fluid in the following manner. Fluid enters the valve through the valve body inlet port and is directed to the fluid chamber. When the valve is in a first position designed to provide a relatively high flow rate delivery of fluid, the valve movable element stem is disposed a relatively shallow depth into the orifice. The relatively shallow stem placement within the orifice exposes a relatively large open surface area between the orifice wall and stem surface features for fluid passage therebetween. As the stem is moved deeper into the orifice, the open surface area between the orifice wall and the stem surface feature or features are reduced, resulting in a corresponding reduction in the flow rate of fluid delivered by the valve in a manner that provides a linear fluid flow curve for the valve.

The ability to control the flow rate of fluid delivered by the valve, especially at low flow conditions, in a manner that is linear relative to stem placement within the valve operates to provide a valve with characteristics of improved stability and repeatability when compared to conventional needle valves.

Accordingly, a feature of metering valves of this invention is that they are specifically designed and constructed to provide a precise, stable and repeatable delivery of fluid at low flow conditions. Precision metering valves of this invention comprise a valve movable element and orifice that are specially designed to provide a substantially linear fluid flow curve when measuring fluid flow rate as a function of movable element placement within the orifice, thereby ensuring a stable and repeatable delivery of fluid that is highly accurate. Further, since precision metering valves of this invention do not make use of dynamic seals and have wetted components that are formed entirely from a chemically inert non-metallic material, e.g., fluoropolymeric material, this operates to eliminate the possibility of process fluid contamination that may occur from deteriorating or corroding materials.

Another feature of precision metering valves of this invention is the design of the valve movable element in the form of a rolling diaphragm, whereby the movable element is capable of being displaced axially within the valve body by the rolling action or rolling transfer of the thin-walled section. The use of such rolling diaphragm minimizes the possibility of movable element failure due to overstressed and/or unsupported flexible portions.

Although limited embodiments of precision metering valves of this invention have been specifically described and illustrated herein, many modifications and variations will be apparent to those skilled in the art. For example, in the metering valve embodiments described above and illustrated, the valve movable element stem includes an outside surface configured to provide the desired fluid delivery flow rate for the valve as a function of movable element placement within the orifice. Alternatively, it is to be understood that instead of or in combination with the movable element stem, metering valves of this invention can be configured having the surface modification giving rise to such desired fluid flow rate delivery characteristics disposed along the inside surface of the orifice. For example, the stem can be configured having a smooth outside surface and the orifice inside wall surface can be configured having one or more recesses or other surface features that operate to provide the desired fluid flow rate delivery characteristics as a function of stem insertion depth within orifice, and that operates to provide a substantially liner flow curve for the valve.

Accordingly, it is to be understood that, within the scope of the appended claims, precision metering valves according to principles of this invention may be embodied other than as specifically described herein.

What is claimed is:

1. A valve comprising:
a body including a fluid inlet port, a fluid outlet port, a fluid chamber interposed therebetween, and an orifice disposed within the fluid chamber, the orifice including an opening and extending a length, wherein the orifice has a substantially constant diameter along the length;
a movable element disposed within the valve body fluid chamber, the movable element comprising:
a stem that is at least partially disposed within the orifice to control the flow of fluid through the valve, wherein at least one of the stem or the orifice includes a surface feature that reduces the flow rate of fluid through the valve with increased insertion depth of the stem within the orifice;
a thin-walled section integral with the stem and extending axially therefrom, the thin-walled section having a cylindrical shape and having a length to facilitate axial movement of the stem by rolling transfer of the thin-walled section from one supporting surface to an adjacent and oppositely oriented supporting surface;
a flange integral with the thin-walled section and extending circumferentially therearound to define a peripheral edge of the moveable element;
an actuator connected to the movable element; and
an actuator housing attached to the valve body, wherein the actuator is disposed within actuator housing.

2. The valve as recited in claim 1 wherein the valve moveable element stem includes one or more surface feature disposed within an outside wall surface of the stem.

3. The valve as recited in claim 2 wherein surface feature is a V-shaped recess that extends axially along the stem outside surface and that has an increasing depth moving towards an end of the stem.

4. The valve as recited in claim 2 wherein the surface feature is a continuous groove that extends helically around the stem.

5. The valve as recited in claim 1 wherein the stem has an axial length that is greater than that of the orifice.

6. The valve as recited in claim 1 wherein the surface feature that reduces the flow rate of fluid is disposed along a wall surface of the orifice.

7. The valve as recited in claim 1 wherein the actuator is connected to the valve movable element by an interlocking connection formed between complementary surface features of the actuator and the movable element.

8. The valve as recited in claim 1 wherein actuator includes an outside surface that supports the movable element thin-walled section when the actuator is in a first position, and the actuator housing includes an inside surface that support the movable element thin-walled section when the actuator is in a second position.

9. The valve as recited in claim 1 wherein the movable element flange is interposed between an open end of the valve body and an adjacent end of the actuator housing, and wherein the flange includes a surface feature that cooperates with an adjacent surface feature of the valve body to form a leak-tight connection therewith.

10. The valve as recited in claim 1 wherein the actuator is rotationally movable within the valve and the movable element is rotationally fixed within the valve body.

11. The valve as recited in claim 1 wherein the actuator includes radially projecting surface feature that contacts an adjacent surface of the actuator housing to guide axial movement of the actuator therein.

12. A precision metering valve comprising:
a one-piece body having a fluid inlet port extending into the body, a fluid outlet port extending out of the housing, a fluid transport chamber disposed within the body and in fluid-flow communication with the fluid inlet and fluid outlet port, and a valve orifice integral with the body and interposed between the fluid inlet passage and fluid outlet passage, the orifice having a substantially constant diameter and a fixed axial length;
a one-piece valve movable element disposed within the fluid transport chamber comprising:
a imperforate stem at one axial end of the movable element and having a diameter sized to fit within the orifice, the stem at least partially movably disposed within the orifice, the stem including at least one recess disposed along a wall surface that defines with an adjacent wall surface of the orifice defines a fluid flow path within the valve;
a thin-walled section integral with the stem and extending axially therefrom, the thin-walled section having a sufficient axial length to enable axial movement of stem relative to the orifice by rolling transfer of the thin-walled section between adjacent and opposed supporting surfaces of the valve;
a flange integral with the thin-walled section and extending radially therefrom, the flange extending circumferentially around the thin-walled section and defining a peripheral edge of the valve movable element;
an actuator housing attached to the valve body; and
an actuator disposed within the housing and connected with the movable element.

13. The valve as recited in claim 12 wherein the fluid flow path defined between the stem and orifice provides a substantially linear relationship between fluid flow rate through the valve as a function of stem position within the orifice.

14. The valve as recited in claim 12 wherein the stem recess is V-shaped and extends axially along the stem outside surface.

15. The valve as recited in claim 14 wherein the recess has an increasing depth moving towards an end of the stem.

16. The valve as recited in claim 12 wherein the stem includes more than one recess.

17. The valve as recited in claim 12 wherein the valve movable element recess is a continuous groove that extends helically around the stem.

18. The valve as recited in claim 12 wherein the actuator is connected to the valve movable element by an interlocking connection formed between complementary surface features of the actuator and the movable element.

19. The valve as recited in claim 12 wherein actuator includes an outside surface that supports the movable element thin-walled section when the actuator is in a first position, and the actuator housing includes an inside surface that support the movable element thin-walled section when the actuator is in a second position.

20. The valve as recited in claim 12 wherein the movable element flange is interposed between an open end of the valve body and an adjacent end of the actuator housing, and wherein the flange includes a surface feature that cooperates with an adjacent surface feature of the valve body to form a leak-tight connection therewith.

21. The valve as recited in claim 12 wherein the actuator is rotationally movable within the valve and the movable element is rotationally fixed within the valve body.

22. A precision metering valve comprising:
a one-piece body having a fluid inlet port extending into the body, a fluid outlet port extending out of the housing, a fluid transport chamber disposed within the body and in fluid-flow communication with the fluid inlet and fluid outlet port, and a valve orifice disposed axially within the fluid chamber and integral with the body, the orifice having a substantially constant diameter extending a fixed axial length;
a one-piece valve axially movable element disposed within the fluid transport chamber comprising:
a imperforate axially projecting stem at one end of the movable element, the stem having a diameter sized to fit within the orifice, the stem including at least one surface feature disposed along a wall surface when disposed within the orifice defines a fluid flow path within the valve, wherein the surface feature is configured to produce reduced fluid flow rate through the valve with increasing insertion depth of the stem within the orifice;
a thin-walled section integral with the stem and extending axially therefrom, the thin-walled section having a sufficient axial length to enable axial movement of stem relative to the orifice by rolling transfer of the thin-walled section between adjacent and opposed supporting surfaces of the valve;
a flange integral with the thin-walled section and extending radially therefrom, the flange extending circumferentially around the thin-walled section and defining a peripheral edge of the valve movable element;
an actuator housing attached to the valve body; and
an actuator disposed within the housing and connected with the movable element.

23. A method for delivering fluid from a valve comprising the steps of:
introducing fluid into a valve body through a fluid inlet port, the valve body including a fluid outlet portion and a fluid chamber interposed between the fluid inlet port and outlet port;
passing the fluid within the valve through a fluid passage between adjacent surfaces of a stem and an orifice, wherein the stem is an integral part of a movable element that is disposed within the fluid chamber, and wherein the orifice is disposed within the fluid chamber and includes a diameter that is sized to accommodate placement of the stem therein, wherein the fluid passage is defined by one or more features of the adjacent stem and orifice; and
delivering fluid that exits the fluid passage from the valve through the fluid outlet.

24. The method as recited in claim 23 further comprising the step of reducing the flow rate of fluid delivered by the valve by increasing the depth that the stem is inserted into the orifice.

25. The method as recited in claim 23 wherein the step of reducing the flow rate is performed by rotating an actuator that is connected with the valve body, which rotation causes the movable element to move axially within the valve body to cause the stem to be further inserted within the orifice, wherein the movable element is rotatably fixed within the valve body.

26. The method as recited in claim 23 wherein the flow rate of fluid through the valve as a function of stem position within the orifice is substantially linear.

27. The method as recited in claim 23 wherein during the step of passing, the fluid passes through the fluid passage that is defined by at least one recessed section disposed along a wall surface of the stem, and wherein the recessed section has an increasing depth moving axially along the stem towards an end of the stem.

28. The method as recited in claim 23 wherein during the step of passing, the fluid passes through the fluid passage that is defined by a helical groove that extends around a wall surface of the stem.
